(19) United States
(12) Patent Application Publication
(10) Pub. No.: US 2006/0097712 A1
(43) Pub. Date: May 11, 2006

(54) Method for controlling the output value of a load system and switching power supply

(75) Inventor: Fritz Wochele, Aidlingen (DE)

Correspondence Address: Eugene I. Shkurko;IBM Corporation - P386, 2455 South Road, Poughkeepsle,, NY, 12601, US

(73) Assignee: International Business Machines Corporation, Armonk, NY (US)

(21) Appl. No.: 11/297,058

(22) Filed: Dec. 8, 2005

(30) Foreign Application Priority Data
Sep. 12, 2004 (EP) 04106430.4

(51) Int. Cl. G05F 1/56; G05F 1/618

(52) U.S. Cl. 323/285

(57) ABSTRACT

A method and switching power supply for controlling the output value of a load system with an input value that varies in dependency of the load mode and other influences of the load system, using a control device, an energy storage means and a hysteresis comparator that compares the actual output value of the load system to a reference output value. These are characterized in that the control device is switched off when the storage means delivers energy to the load system in a low load mode of the load system.

### FIELD OF THE PRESENT INVENTION

The present invention relates to a method for controlling/regulating an output value. An input value can vary in dependency of a load mode and other influences. The method is using a control device, an energy storage means and a hysteresis comparator that compares the actual output value of the system to a reference value. The present invention relates further to a switching power supply for controlling the output value of a system, especially a power supply system, with an input value that varies in dependency of the load mode and other influences, comprising a control device, an energy storage means and a hysteresis comparator that compares the actual output value of the load system to a reference value.

### BACKGROUND OF THE PRESENT INVENTION

The principle of the present invention can be applied in any converter topology if there is a big demand variation of the output media (electrical energy, pneumatic energy, hydraulic energy, water energy etc) and if the energy consumption of the regulator/controller itself is essential.

### STATE OF THE ART

A prior art switching power supply comprises for example an output capacitor to store energy a reference voltage, an oscillator or pulse generator, an amplifier and/or a comparator, a power pass device and other means to ensure proper and safe operation. The actual output voltage is compared to the reference voltage. If there is a deviation of the output voltage due to input voltage variations or load changes, the power pass device gets stimulated in a way that the output value is kept almost constant. All parts, at least in the control loop (amplifier comparator oscillator etc.) of the regulator controller/system are always supplied with energy and consume continuously energy.

### OBJECT OF THE PRESENT INVENTION

Starting from this, an object of the present invention is to provide a method for controlling the output value of a system with an input value that varies in dependency of the load mode and other influences of the system, using a control device, an energy storage means and a hysteresis comparator that compares the actual output value of the load system to a reference output value, said method being suitable to maintain a constant output value in an easy way. A further object of the present invention is to provide a switching power supply for controlling the output value of a load system, especially a power supply system, with an input value that varies in dependency of the load mode and other influences of the load system, comprising a control device, an energy storage means and a hysteresis comparator that compares the actual output value of the load system to a reference output value, said switching power supply being suitable to maintain a constant output value in an easy way.

### BRIEF SUMMARY OF THE INVENTION

The present invention provides a new method for controlling the output value of a load system with an input value that varies in dependency of the load mode and other influences of the system, using a control device, an energy storage means and a hysteresis comparator that compares the actual output value of the load system to a reference output value.

The new method is characterized in that the most parts of the system (the amplifier, pulse generator and the control device) are switched off when the storage means delivers energy to the load system in a low load mode of the load system. According to the present invention, the energy consumption of the controller/regulator is adapted to the energy consumption of the load. The present invention is based on the idea to switch off the most parts of the system (the amplifier, pulse generator and the control device) in a state of low energy consumption in the load system. The inventive method is to be applied in any converter topology if there is a big variation of the load and if the energy consumption in the low load mode of the converter itself, gets in the same range or even greater than the load energy.

A preferred embodiment of the method is characterized in that the most parts of the system (the amplifier, pulse generator and the control device) are switched off when the load of the load system falls below a minimal load value. The minimal load value defines the low load mode of the system. Only in the low load mode of the load system the most parts of the system (the amplifier, pulse generator and the control device) are switched off, but not in a high load mode of the load system.

A further preferred embodiment of the method is characterized in that the hysteresis comparator and the reference output value are kept switched on when the energy storage means delivers energy to the load system in a low load mode of the load system. The control device is switched off.

A further preferred embodiment of the method is characterized in that the output value of the load system is the output voltage of a power supply. Nevertheless, the output value of the load system may also be other physical values like pressure, of a hydraulic system, temperature, electrical current, water current, water level etc. The method can be applied for regulating/controlling all types of energy.

The present invention further provides a new switching power supply for controlling the output value of a load system, especially a power supply system, with an input value that varies in dependency of the load mode and other influences of the load system, comprising a control device, an energy storage means and a hysteresis comparator that compares the actual output value of the load system to a reference output value.

The new switching power supply is characterized in that the control device is constructed to switch off when the storage means delivers energy to the load system in a low load mode of the load system. The new switching power supply is useful in any application where energy saving is essential and if there is a big demand variation of the output media (electrical energy, pneumatic energy, hydraulic energy, water energy etc).

A preferred embodiment of the switching power supply is characterized in that the characteristic curve of the output from the control device increases with a steep gradient when the load of the load system falls below a minimal load value. The minimal load value of the load system defines a low load mode of the load system. Only in the low load mode of the load system the control device is switched off, but not in a high load mode of the load system.

A further preferred embodiment of the switching power supply is characterized in that the control device switches off when the output value of the load system reaches a high level output value. When the control device is switched off, then the load of the system causes the output value of the load system to decrease.

A further preferred embodiment of the switching power supply is characterized in that the control device switches on when the output value of the load system reaches a low level output value. When the control device is switched on, then the output value of the load system increases.

The present invention relates further to a load system with an input value that varies in dependency of the load mode and other influences of the load system, with a switching power supply as described above, operating according to a method as described above.

The present invention relates further to a computer program product stored in the internal memory of a digital computer, containing parts of software code to execute the above described method.

### BRIEF DESCRIPTION OF THE DRAWINGS

The above, as well as additional objectives, features and advantages of the present invention will be apparent in the following detailed written description.

The novel features of the present invention are set force in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1 shows a functional diagram of the present invention;

FIG. 2 shows a system of Cartesian coordinates, in which the output value of a load system is represented over the time;

FIG. 3 shows a system of Cartesian coordinates, in which the output value of the load system is represented over the load of the load system;

FIG. 4 shows a circuit in accordance with a first embodiment of the present invention;

FIG. 5 shows a circuit in accordance with a second embodiment of the present invention and

FIG. 6 shows a further functional diagram of the present invention.

### DETAILED DESCRIPTION OF THE DRAWINGS

The following principle was found at the development of a power supply for automotive electronic. It also has advantages in many other battery operated equipment.

The Design targets are:
1. Low quiescent current
2. Low cost
3. Good regulation characteristic at load and input voltage changes
4. High efficiency over a very high Load range (1:100000)
5. Low ripple voltage at medium and high load

Commercially available parts can only partly satisfy this combination of requirements. Mostly separate circuits are used which complement the requirements.

This principle can be applied in any converter topology if there is a big variation of the load and if the energy consumption in the low load mode of the converter itself, gets in the same range or even greater than the load energy.

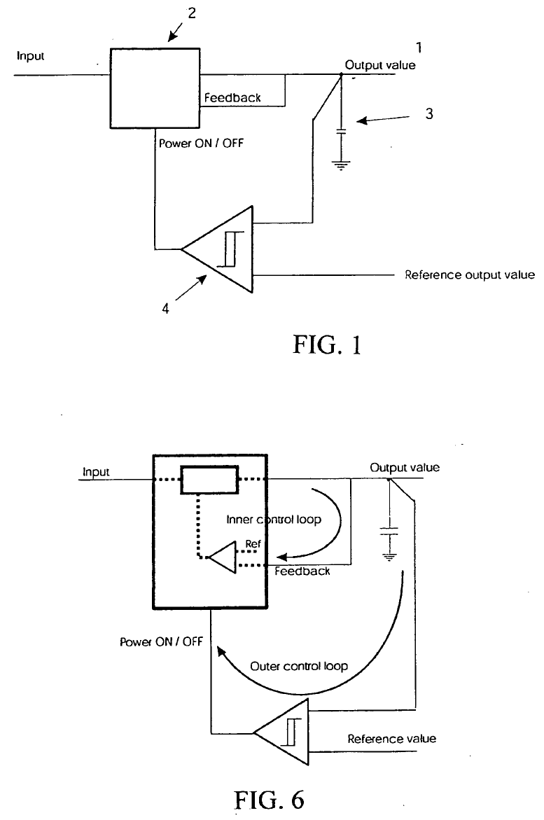

FIG. 1 shows a functional diagram of a power supply system 1 according to the present invention. The power supply system 1 comprises a device control 2, an energy storage means 3 and a hysteresis comparator 4. Hysteresis comparator 4 compares the actual output value to a reference output value of power supply system 1. Device control 2 is switched on and off by hysteresis comparator 4. According to the present invention, the switching of device control 2 takes place only in a low load mode of power supply system 1. The term low load mode means that the load of power supply system 1 falls below a minimum load Lmin. If the load of power supply system 1 exceeds Lmin, device control 2 is kept switched on. The efficiency of power supply system 1 may be improved in a high degree by switching of device control 2 temporary.

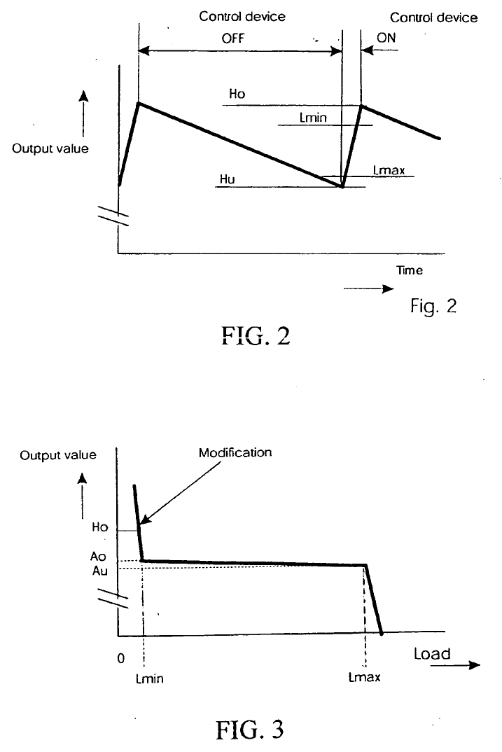

FIG. 2 shows a system of Cartesian coordinates, in which the output value of a load system is represented over the time. The load of power supply system 1 is below a minimum load Lmin. If device control 2 is switched off, the load of power supply system 1 causes the output value to decrease continuous until a minimum value Hu is reached. Then hysteresis comparator 4 switches device control 2 on. The output value of power supply system 1 increases until a maximum value Ho is reached. At this point device control 2 is switched off again.

FIG. 3 shows a system of Cartesian coordinates, in which the output value of power supply system 1 is represented over the load of the load system. Device control 2 is modified in a way that the output value increases with a steep gradient when the load of power supply system 1 falls below the minimal load value Lmin. If the load exceeds Lmin, device control 2 is kept switched on. Then the output value varies between Ao and Au.

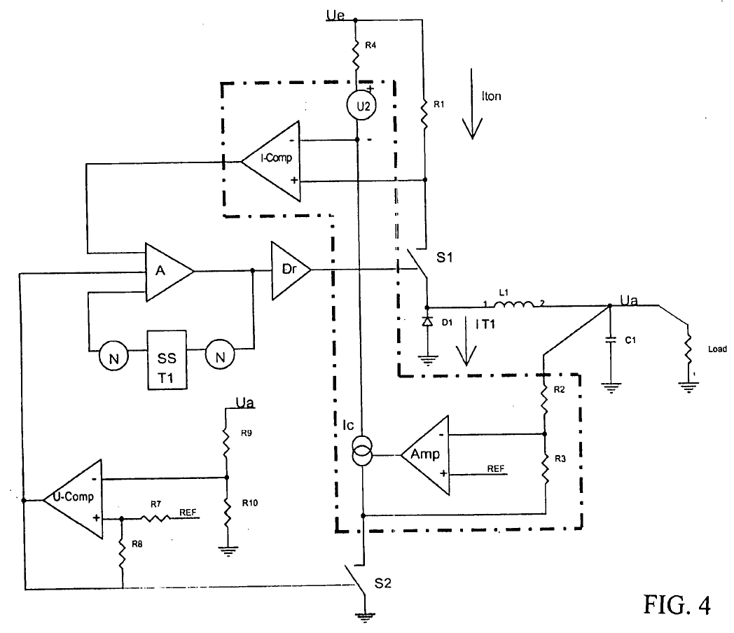

FIG. 4 shows a circuit in accordance with a first embodiment of the present invention. This example describes the principle in a step down (buck) converter topology.

When S1 is closed via the driver (Dr) an increasing current
Iₜₒₙ≈(Ue−Ua)Ton/L1
flows from Ue to Ua via R1, S1 and L1. This current causes a voltage drop across R1. If this drop gets greater than (Ic*R4)+U2 the output of I-comp gets inactive, blocks gate A and opens S1. Gate A stays off for the time T1 due to the single shot (SS) which is connected between output and input of gate A. Since the inductor doesn't allow a sudden current change, the current will continue to flow through D1.
It will decrease by
I_{T1}≈Ua*T1/L1
or get to zero. After T1, the switch S1 turns on again etc.

As long as Ua*R3/(R2+R3)<REF, the output of Amp is at its maximum value and so is Ic and the voltage drop across R4. This is the condition where Iₜₒₙ also reaches its max value before I-comp changes state. In this state the maximum energy is transferred from Ue to Ua with each cycle. As a result Ua will increase. This continues until Ua reaches its nominal value. Then the Amp gets in its linear region and decreases Ic. This will also decrease Iₜₒₙ, so that the transferred Energy gets in a balance with the load at the output and Ua is held constant.

This mode is called current mode because the regulation action is done cycle by cycle via the current Iₜₒₙ.

During all the above action the output of U-comp (U-comp is a comparator with hysteresis) is active because its upper switching voltage (U_{comp-high}) is set slightly higher than the voltage were Amp is in its linear range.

If the load current gets smaller and smaller, Ua rises slightly and Ic will decrease until it gets zero. Even if Ic is zero, Iₜₒₙ will not get down to zero, because there is a voltage source (U2) in series with R4. This limits the minimum amount of Iₜₒₙ to the value
Iₜₒₙₘᵢₙ=U2/R1.

If the load is so low, that it cannot get in balance with the energy transferred by Iₜₒₙₘᵢₙ, the output voltage Ua will further increase until it reaches U_{comp-high}. Then U-comp will change its output to low and block gate A. It also opens S2 and shuts off power to all circuitry in the dashed Box.

In this state the energy consumption of the circuit is extremely low, since the only part what consumes energy is U-comp. This status remains, until some load at the output discharges the energy storage capacitor C1 down to the lower switching voltage of U-comp (U_{comp-low}).

Then the driver closes S1 again and starts the current mode action again. If the load is now at least big enough to get in balance with the energy transferred by Iₜₒₙₘᵢₙ the circuit will stay in the current mode. If the load is to low the circuit will transfer some energy in a few switching cycles, increase Ua and return to the state were U-comp is switched off. The mode where U-comp always switches on and off is called hysteretic mode.

In the current mode, the circuit reacts very quickly to any changes of Ue and the load (Good regulation characteristics).

The output voltage shows a very small amount of ripple voltage due to continuous switching action.

The efficiency is high because of quasi continuous current flow to the output. The decrease of efficiency due to energy consumption of the circuit is very small.

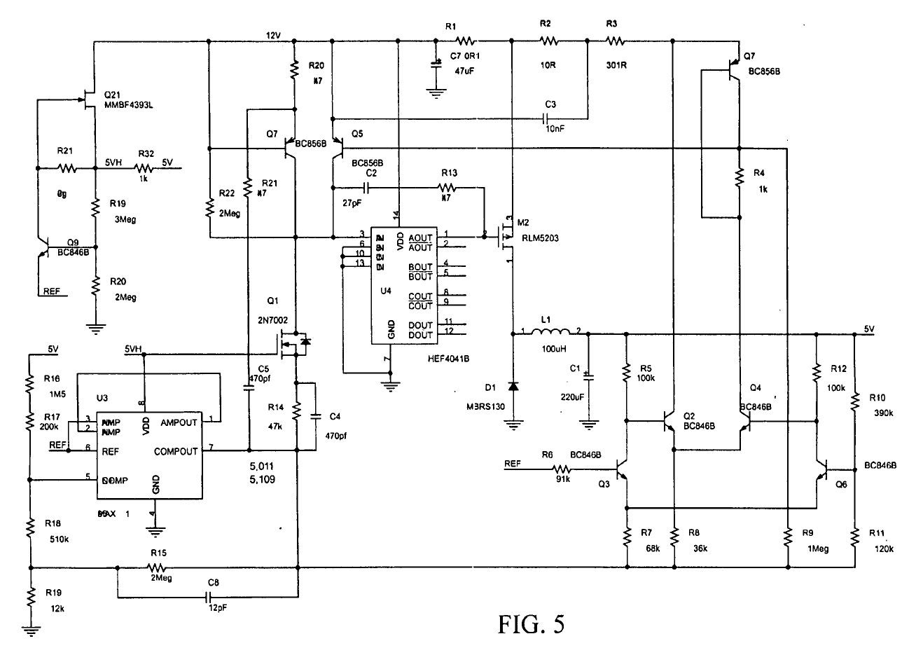

Example: If the current consumption of the circuitry in the dashed box is around 100 uA as in the circuit of FIG. 5 and the current limit, were the circuit changes from hysteretic mode to current mode is set to 50 mA. It results in an efficiency decrease of only 0.2% at the extreme limit of current mode operation! For higher loads the decrease gets smaller.

In hysteretic mode the circuit has also a high efficiency, because during the off time of the U-comp all the mayor energy consumers are turned off. The ratio between on- and off time varies with the load and for very light load conditions it will be 1:10⁵ or more. The switchover load current from one mode to the other is easy to adjust by varying the value of U2.

In the example the quiescent current (operating current of the circuit with no load) is only ˜12 uA and can be further decreased by using other components.

Since conductive losses are proportional to I², it is more advantageous to have a lower current during the full time, than a high current during intervals, as it would be if the circuit worked for all loads in hysteretic mode.

In the example there are the following settings:

U_{comp-high}=5.1V; U_{comp-low}=5.0V; linear range of amp=5.030 to 5.070V (U_{comp-low} could be set to a higher value as well e.g. 5.05V) But it is necessary, that U_{comp-high} is higher than the linear range of amp.

It should be mentioned that this principle can be combined with other measures to further increase efficiency, for example synchronous rectification. Here a conducting FET is connected in parallel to D1 while S1 is off (current mode only) That will lower the forward voltage of the diode (˜0.5V) to a value of well below 100 mV.

When designing the Amp the general stability criteria have to be obeyed. In the example no measures were necessary due to the relative low gain of amp. In the hysteretic mode stability is uncritical (2 point control).

FIG. 4 shows a circuit in accordance with a first embodiment of the present invention. The MAX 951 (U3) is used as U-comp and reference. The reference voltage is 1.2V. The Amp consists of the transistors Q2, Q3, Q4 and Q6. The output of the Amp is the collector of Q4. I-comp consists of the transistors Q5 and Q7. U4 is the driver Dr and M2 is the switch S1. The function of gate A is established by the collector of Q5 and the drain of Q1. C2 and R13, connected from the output to the input of Dr provide the single shot (SS) function. It works together with the current source Ql, R14. The output of U-comp (U3-7) switches this current source on and off. Q7, R20-R22 and C5 are optional. This circuitry speeds up the pos transition of compout to the input of gate A (U4-3). The negative supply rail of the Amp is connected to compout and gets thereby switched on and off.

The function of I-comp is not very obvious and will be explained in detail.

Normal Current Regulation

If there is no current flow through M2, the emitters of Q5 and Q7 are almost at the same voltage (disregard R2 and R3 for now). The base voltages of the two transistors are different by the amount of U_{beQ5}−U_{beQ7}=I_{CQ4}*R4.

If there is a voltage drop across R1 which equals this amount, the current through Q5 will be the same as through Q7. If this current is greater than ≈80 uA (Current source Q1, R14) Gate A input will be pulled high and opens S1. This is how the Amp controls the peak current through S1 with IC_{Q4}.

Function of U2 if ICQ4 is Zero

As long as the output voltage is above the linear range of Amp, no current will flow through Q4 and R4. The base voltages of Q5 and Q7 are equal. There is a small current (11 uA) flowing through Q7 caused by R9. Because Q5 and Q7 have about the same conditions there will flow about the same small current through Q5.

Since it takes 80 uA to pull the input of gate A high, Q5 needs a higher Ube to supply it. It needs a small voltage drop across R1 (minimum current) to pull all terminals of Q7 lower and turn on Q5.

Without any other measures the additional voltage drop would be around 50 mV (effective value of U2). R3 was built in to lower this amount. The drop across R3 is about 30 mV, so the remaining required drop is 20 mV. It is not recommended to decrease this value any further because the remaining value must always be greater than the dispersal of U_{BEQ5} and U_{BEQ7}.

R2 and C3 are low pass filters to avoid switching spikes. Q9, Q21 are a linear regulator with a voltage of 4.4V. It supplies U3 at startup. It is turned off, as soon as the output voltage comes up.

With the values shown, the circuit changes from hysteretic to current mode above 50 mA. The short circuit current is 600 mA.

Furthermore it is characteristic of this principle that there are at least two nested control loops. The outer loop switches the inner loop either always on, or on and off. This is dependent on the load. To make this work, the inner loop must have a behavior according to FIG. 3.

FIG. 6 shows a principle that combines two (can be more) regulation principles. An inner loop must have a characteristic which leaves the normal operation values under certain conditions. (E.g. Voltage rises under low load). Then an outer loop takes control. This principle can be used also to combine different characteristics, not only to save energy.

1. Method for controlling the output value of a load system with an input value that varies in dependency of the load mode and other influences of the load system, using a control device, an energy storage means and a hysteresis comparator, comprising the steps of:
comparing the actual output value of the load system to a reference output value, and
switching off the control device when the storage means delivers energy to the load system in a low load mode of the load system.

2. Method according to claim 1, further comprising the step of:
switching off the control device when the load of the load system falls below a minimal load value.

3. Method according to claim 1, further comprising the step of:
keeping the hysteresis comparator and the reference output value switched on when the energy storage means delivers energy to the load system in a low load mode of the load system.

4. Method according to claim 1, wherein the output value of the load system is the output voltage of a power supply.

5. A switching power supply for controlling the output value of a power supply system, with an input value that varies in dependency of the load mode and other influences of the load system, comprising:
a control device,
an energy storage means,
a hysteresis comparator that compares the actual output value of the load system to a reference output value, and
wherein the control device is constructed to switch off when the storage means delivers energy to the load system in a low load mode of the load system.

6. A switching power supply according to claim 5, wherein the characteristic curve of the output from the control device increases with a steep gradient when the load of the load system falls below a minimal load value.

7. A switching power supply according to claim 5 wherein the control device switches off when the output value of the load system reaches a high level output value.

8. A switching power supply in accordance with claim 5 to wherein the control device switches on when the output value of the load system reaches a low level output value.

10. A computer program product containing computer executable instructions for performing the method steps of claim 1.
